(19) United States
(12) Patent Application Publication
(10) Pub. No.: US 2008/0312016 A1
(43) Pub. Date: Dec. 18, 2008

(54) Light weight Chain Wheel Having Concrete Structure

(76) Inventors: Douglas Chiang, Taichung hsien (TW); Hsiu-Chih Wang, Taipei (TW)

Correspondence Address: Douglas CHIANG, 235 Chung-Ho Box 8-24, Taipei, 235, TW

(21) Appl. No.: 11/762,765

(22) Filed: Jun. 13, 2007

(51) Int. Cl. F16H 7/14

(52) U.S. Cl. 474/116

(57) ABSTRACT

A chain wheel comprises a chain wheel body formed with a plurality of combining holes for assembly a crank of a bicycle and a plurality of through holes for riveting so that the chain can be engaged with different chain wheel body for speed change; the chain wheel body including an outer periphery and an inner periphery; the outer periphery being formed with a teeth portion with a plurality of tooth for engaging with a chain; a coarse portion formed at a back surface of the chain wheel body; and a combining portion covering upon a part of the outer periphery and both at the front surface and back surface of the chain wheel body; the combining portion being extended through the inner periphery so as to be combined as an integral body at both the front surface and back surface of the chain wheel body.

### FIELD OF THE INVENTION

The present invention relates to bicycle chain wheels, and particularly to a chain wheel with a concrete structure and having a light weight by using a coarse portion and a combining portion.

### BACKGROUND OF THE INVENTION

The bicycle has treadles. Each treadle is connected to a crank. A crank shaft is connected between the two cranks. The crank shaft has a chain wheel. The chain wheel is engaged with a chain for driving a rear wheel so as to drive the bicycle to move forwards. The structure of the chain and chain wheel is widely used in many fields, such as vehicles, machines. Other than actuating the movement of a machine, moreover, the ratio of the teeth between chain wheels has the effects of acceleration and deceleration.

One prior art, Taiwan Patent No. 095206785, soundless transfer chain wheel structure, disclosed a rigid disk with a predetermined radius. A center thereof has a retaining hole for positioning a shaft. A plurality of chain teeth is formed radially for engaging a chain. Two sides of the rigid disk are installed with respective elastic disks axially. The elastic disk is adjacent to the chain teeth of the rigid disk. Thereby each elastic disk is formed with a recess for receiving a chain. A lower side of each receiving space is vertically formed with a buffer portion with respect to the lower side of the transfer chain and a guide portion vertically resisting against the parallel shaft at the two sides of the transfer chain. Thus, noise is reduced and the lifetime of the chain is prolonged.

The prior art structure has the elastic disks at two sides thereof and the chain is in contact with the elastic disks. Thus noise due to friction therebetween is reduced. When the chain resists against the elastic disks, it is easy that the elastic disks will separate from the rigid disk so that the effect of reduction of noise is lost. Moreover, the prior art structure only has the effect of noise reduction, but it is heavy. Thus it is not suitable to be used in a competition bicycle. In fact, a reduction of the 100 grams to the weight of the bicycle has a great effect to the result of the competition, while the elastic disks at two sides increase the weight of the bicycle.

### SUMMARY OF THE INVENTION

Accordingly, the primary object of the present invention is to provide a chain wheel with a concrete structure and having a light weight by using a coarse portion and a combining portion.

To achieve above objects, the present invention provides a chain wheel comprising: a chain wheel body formed with a plurality of combining holes for assembly a crank of a bicycle and a plurality of through holes for riveting so that the chain can be engaged with different chain wheel body for speed change; the chain wheel body including an outer periphery and an inner periphery; the outer periphery being formed with a teeth portion with a plurality of tooth for engaging with a chain; a coarse portion formed at a back surface of the chain wheel body; a combining portion covering upon a part of the outer periphery and both at the front surface and back surface of the chain wheel body; the combining portion being extended through the inner periphery so as to be combined as an integral body at both the front surface and back surface of the chain wheel body. By the installation of the coarse portion, the weight of the chain wheel body is light; in engagement, the chain resists against the combining portion; the friction between the chain and the chain wheel body is reduced and the wear and noise therebetween is also reduced; the combining portion is extended from the front surface to the back surface of the chain wheel body so that it is firmly secured to the chain wheel body with a greater combining strength; when the combining portion contacts with the chain, it will not fall out easily.

The various objects and advantages of the present invention will be more readily understood from the following detailed description when read in conjunction with the appended drawing.

### BRIEF DESCRIPTION OF THE DRAWINGS

FIG. 1 is a schematic view about the chain wheel body of the present invention, especially the coarse portion is illustrated.

FIG. 2 is a schematic view along line AB of FIG. 1.

FIG. 3 is a schematic view showing the back surface of the chain wheel body of the present invention.

FIG. 4 is a schematic cross sectional view along line CD of FIG. 3.

FIG. 5 is a schematic perspective view about the combining portion in the front surface of the present invention.

FIG. 6 is a schematic perspective view about the front surface of the present invention, wherein the surface is covered by a combining portion.

FIG. 7 is an assembled schematic view about the chain wheel body of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

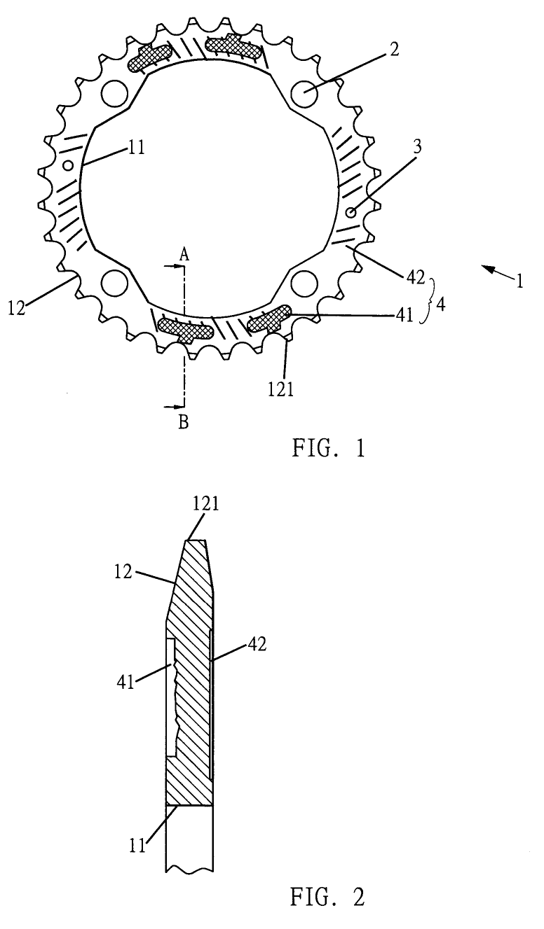

Referring to FIG. 1 to 4, the structure of the present invention is illustrated. In the present invention, the chain wheel body 1 is installed to a bicycle for assembly with a crank 5. The chain wheel body 1 is a round ring. In the following, the surface of the chain wheel body 1 combining with the crank 5 is set as a front surface and the side opposite to the front surface is a back surface.

The chain wheel body 1 is formed with a plurality of combining holes for assembly a crank 5 of a bicycle and a plurality of through holes 3 for riveting so that the chain can be engaged with different chain wheel body 1 for speed change.

The chain wheel body 1 includes an outer periphery 12 and an inner periphery 11. The outer periphery 12 is formed with a teeth portion 121 with a plurality of tooth for engaging with a chain.

The back surface of the chain wheel body 1 is formed with a coarse portion 4. The coarse portion 4 includes a first embedding portion 11 and a second coarse portion 42. The first coarse portion 41 is formed as a netlike texture and the second coarse portion 42 is formed as a crack texture. The depth of the first coarse portion 41 is greater than that of the second coarse portion 42. As shown in FIG. 1, the first coarse portion 41 is installed at an upper and a lower side of the chain wheel body 1 and is symmetrical to a center of the chain wheel body 1. The second coarse portion 42 is installed at an upper, lower, left and right sides of the chain wheel body 1 and is also symmetrical to the center of the chain wheel body 1.

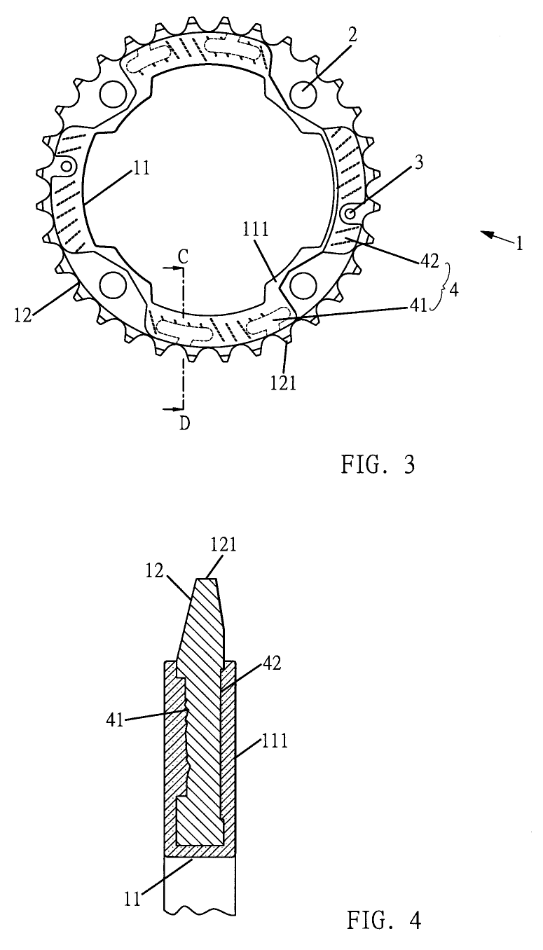

With reference to FIGS. 3 and 4, a combining portion 111 covers upon a part of the outer periphery 12 and both at the front surface and back surface of the chain wheel body 1. See FIG. 4, the combining portion 111 is extended through the inner periphery 11 so as to be combined as an integral body at both the front surface and back surface of the chain wheel body 1. The combining portion 111 covers the coarse portion 4 including the first coarse portion 41 and second coarse portion 42 and the combining portion 111 completely fills the first coarse portion 41 and second coarse portion 42, but the combining portion 111 do not covers the through holes 3 and the combining holes 2. Thus the teeth portion 121, through holes 3 and combining holes 2 can be used normally. Furthermore see FIG. 4, the combining portion 111 is higher than the teeth portion 121, and thus, when the chain is engaged to the teeth portion 121, it can resist against the combining portion 111. The combining portion 111 is combined to the chain wheel body 1 by plastic injection.

By the installation of the coarse portion 4, the weight of the chain wheel body 1 is light. Furthermore, in engagement, the chain resists against the combining portion 111. The friction between the chain and the chain wheel body 1 is reduced and the wear and noise therebetween is also reduced. Thereby the combining portion 111 is extended from the front surface to the back surface of the chain wheel body 1 so that it is firmly secured to the chain wheel body 1 with a greater combining strength. When the combining portion 111 contacts with the chain, it will not fall out easily.

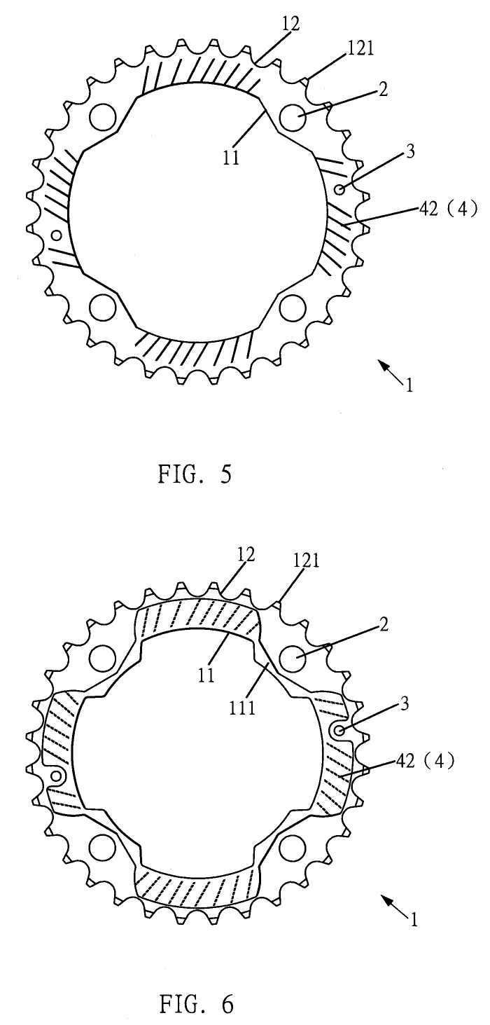

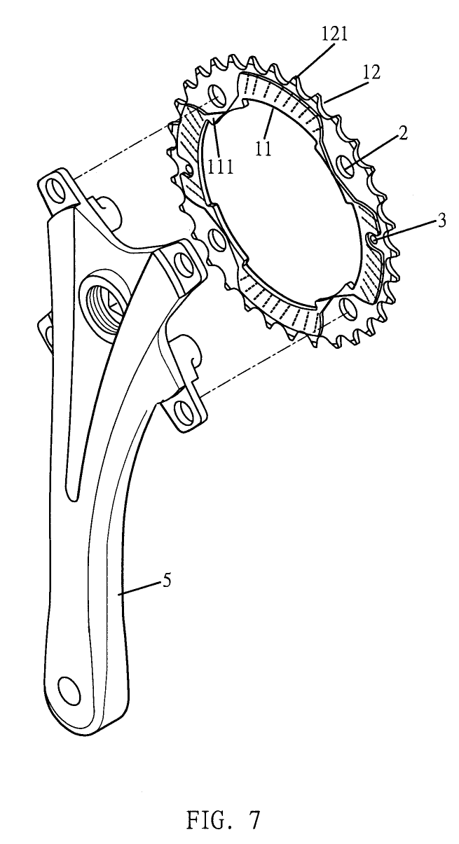

Referring to FIGS. 5 and 6, the schematic view about the front surface of the chain wheel body 1 is illustrated. See FIG. 5, it is illustrated that the second coarse portion 42 is also formed at the upper, lower, left and right side of front surface of the chain wheel body 1. From right side of the FIG. 2, it is illustrated that the first coarse portion 41 in the front surface of the chain wheel body 1 is deeper than the first coarse portion 41 in the backs side thereof. See FIG. 6, the combining portion 111 is extended through the inner periphery 11 so as to be combined as an integral body at both the front surface and back surface of the chain wheel body 1. The combining portion 111 covers the coarse portion 4 including the first coarse portion 41 and second coarse portion 42 and the combining portion 111 completely fills the first coarse portion 41 and second coarse portion 42.

The combining portion 111 do not covers the through holes 3 and the combining holes 2. Thus the teeth portion 121, through holes 3 and combining holes 2 can be used normally. Furthermore see FIG. 4, the combining portion 111 is higher than the teeth portion 121, and thus, when the chain is engaged to the teeth portion 121, it can resist against the combining portion 111. The combining portion 111 is combined to the chain wheel body 1 by plastic injection. By the installation of the coarse portion 4, the weight of the chain wheel body 1 is light. Furthermore, in engagement, the chain resists against the combining portion 111. The friction between the chain and the chain wheel body 1 is reduced and the wear and noise therebetween is also reduced. Thereby the combining portion 111 is extended from the front surface to the back surface of the chain wheel body 1 so that it is firmly secured to the chain wheel body 1 with a greater combining strength. When the combining portion 111 contacts with the chain, it will not fall out easily.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A chain wheel comprising:
a chain wheel body formed with a plurality of combining holes for assembly a crank of a bicycle and a plurality of through holes for riveting so that the chain can be engaged with different chain wheel body for speed change;
the chain wheel body including an outer periphery and an inner periphery; the outer periphery being formed with a teeth portion with a plurality of tooth for engaging with a chain;
a coarse portion formed at a back surface of the chain wheel body;
a combining portion covering upon a part of the outer periphery and both at the front surface and back surface of the chain wheel body; the combining portion being extended through the inner periphery so as to be combined as an integral body at both the front surface and back surface of the chain wheel body;
wherein by the installation of the coarse portion, the weight of the chain wheel body is light; in engagement, the chain resists against the combining portion; the friction between the chain and the chain wheel body is reduced and the wear and noise therebetween is also reduced; the combining portion is extended from the front surface to the back surface of the chain wheel body so that it is firmly secured to the chain wheel body with a greater combining strength; when the combining portion contacts with the chain, it will not fall out easily.

2. The chain wheel as claimed in claim 1, wherein the combining portion covers the coarse portion and the combining portion completely fills the coarse portion, but the combining portion do not covers the through holes and the combining holes.

3. The chain wheel as claimed in claim 1, wherein the coarse portion includes a first coarse portion and a second coarse portion.

4. The chain wheel 1 as claimed in claim 1, wherein the combining portion is combined to the chain wheel body by plastic injection.

5. The chain wheel as claimed in claim 1, wherein the coarse portion includes a first embedding portion and a second coarse portion; the first coarse portion is formed as a netlike texture and the second coarse portion is formed as a crack texture.

6. The chain wheel as claimed in claim 1, wherein a depth of the first coarse portion is greater than that of the second coarse portion.

7. The chain wheel as claimed in claim 1, wherein the first coarse portion is installed at an upper and a lower side of the chain wheel body and is symmetrical to a center of the chain wheel body.

8. The chain wheel as claimed in claim 1, wherein the second coarse portion is installed at an upper, a lower, a left and a right side of the chain wheel body and is symmetrical to the center of the chain wheel body.
